(19) United States
(12) Patent Application Publication
(10) Pub. No.: US 2020/0147430 A1
(43) Pub. Date: May 14, 2020

(54) INTERCONNECTED FIRE DETECTION AND EXTINGUISHING SYSTEM

(71) Applicant: Kidde Technologies, Inc., Wilson, NC (US)

(72) Inventor: Mark P. Fazzio, Wilson, NC (US)

(21) Appl. No.: 16/188,436

(22) Filed: Nov. 13, 2018

(51) Int. Cl. A62C 37/44; A62C 3/08; A62C 35/68

(52) U.S. Cl. CPC A62C 37/44; A62C 35/68; A62C 3/08

(57) ABSTRACT

Provided are embodiments including a method, device and system for an interconnected fire detection and extinguishing system that is implemented in an integrated manner The embodiments include a detector for detecting a condition associated with at least one of a fire or smoke, and an extinguisher operably coupled to the detector, wherein the extinguisher includes an extinguishing agent. The embodiments also include a wireless communication module for exchanging messages with another integrated device based on the detected condition, and a device housing, wherein the detector, the extinguisher, and wireless module are at least partially in the device housing

### BACKGROUND

Exemplary embodiments pertain to the art of fire management systems, and more particularly to an interconnected fire detection and extinguishing system.

Current aircraft cargo fire protection systems use detectors that are located within the cargo bay, and the detectors are also wired to a controller. The controller can be wired to a series of high rate discharge and low rate discharge extinguishers. When smoke or fire is detected, the detectors communicate with the controller which sends a signal to the extinguishers to initiate discharge through a network of tubing and nozzles to suppress the fire. Oftentimes, the different aircraft require unique extinguishers and tubing that are specifically designed for each aircraft.

### BRIEF DESCRIPTION

According to an embodiment, an integrated device used in an interconnected fire detection and extinguishing system is shown. The integrated device includes a detector for detecting a condition associated with at least one of a fire or smoke; an extinguisher operably coupled to the detector, wherein the extinguisher includes an extinguishing agent; a wireless communication module for exchanging messages with another integrated device based on the detected condition; and a device housing, wherein the detector, the extinguisher, and wireless module are at least partially in the device housing.

In addition to one or more of the features described herein, or as an alternative, further embodiments include a detector that is at least one of a smoke detector, a fire detector, or an optical sensor.

In addition to one or more of the features described herein, or as an alternative, further embodiments include extinguishers that include at least one of a high rate discharge extinguisher and a low rate discharge extinguisher.

In addition to one or more of the features described herein, or as an alternative, further embodiments include messages that include state information of the integrated device.

In addition to one or more of the features described herein, or as an alternative, further embodiments include state information that includes an integrated device ID, a pressure level, fault information, or a battery charge level.

In addition to one or more of the features described herein, or as an alternative, further embodiments include an integrated device that is in a cargo storage container.

In addition to one or more of the features described herein, or as an alternative, further embodiments include an integrated device that is in an aircraft cargo bay.

According to another embodiment, a method for operating an interconnected fire detection and extinguishing system is provided. The method includes detecting a condition; triggering an integrated device based at least in part on the detected condition; and transmitting a message to one or more devices based on the detected condition, wherein the integrated device includes a detector for detecting the condition, an extinguisher including an extinguishing agent, a wireless communication module for exchanging the message with the one or more supplemental devices, and a device housing, wherein the detector, the extinguisher, and wireless module are at least partially in the device housing.

In addition to one or more of the features described herein, or as an alternative, further embodiments include one or more supplemental devices include at least one integrated device of an aircraft system.

In addition to one or more of the features described herein, or as an alternative, further embodiments include a detector that is at least one of a smoke detector, a fire detector, or an optical sensor.

In addition to one or more of the features described herein, or as an alternative, further embodiments include extinguishers that include at least one of a high rate discharge extinguisher and a low rate discharge extinguisher.

In addition to one or more of the features described herein, or as an alternative, further embodiments include sending messages including state information of the integrated device.

In addition to one or more of the features described herein, or as an alternative, further embodiments include state information including an integrated device ID, a pressure level, fault information, or a battery charge level.

In addition to one or more of the features described herein, or as an alternative, further embodiments include an integrated device that is in a cargo storage container.

In addition to one or more of the features described herein, or as an alternative, further embodiments include an integrated device that is in an aircraft cargo bay.

According to a different embodiment, an interconnected fire detection and extinguishing system is provided. The system includes one or more integrated devices that are operably coupled to one or more other integrated devices; wherein the one or more integrated devices and the one or more other integrated devices include a detector for detecting a condition, an extinguisher including an extinguishing agent, a wireless communication module for exchanging messages with one or more supplemental devices, and a device housing, wherein the detector, the extinguisher, and wireless module are at least partially included in the device housing.

In addition to one or more of the features described herein, or as an alternative, further embodiments include one or more supplemental devices including at least one integrated device of an aircraft system.

In addition to one or more of the features described herein, or as an alternative, further embodiments include a detector that is a smoke detector, fire detector, and optical detector, and wherein the extinguisher includes at least one of a high rate discharge extinguisher and a low rate discharge extinguisher.

In addition to one or more of the features described herein, or as an alternative, further embodiments include messages including an integrated device ID, a pressure level, fault information, or a battery charge level.

In addition to one or more of the features described herein, or as an alternative, further embodiments include one or more integrated devices that are located in a cargo storage container or located in an aircraft cargo bay.

Technical effects of embodiments of the present disclosure provide a common device that integrates a detector, one or more extinguisher(s), and a wireless communication module into a single device that can be easily installed in a cargo area. In addition, the same integrated device can be installed within a storage container located in the cargo area to provide advanced protection against fires originating within the storage container.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a prior art fire detection and extinguishing system;

FIG. 2 is an integrated device used in a system for operating an interconnected fire detection and extinguishing system in accordance with one or more embodiments;

FIG. 3 depicts a system for an interconnected fire detection and extinguishing system in accordance with one or more embodiments;

FIG. 4 depicts another system for an interconnected fire detection and extinguishing system in accordance with one or more embodiments; and

FIG. 5 is a flowchart of a method for an interconnected fire detection and extinguishing system in accordance with one or more embodiments.

### DETAILED DESCRIPTION

Components of a fire and extinguishing systems are often provided in a non-integrated fashion. The components include high rate discharge (HRD) extinguishers that are initially used to put out the fire and low rate discharge (LRD) extinguishers that are subsequently triggered to manage the remaining fire. These two different types of extinguishers require different types of equipment for connection to the fire extinguishing system. These extinguishers also have different sizes that have different tubing requirements. In addition, these devices also require wiring that must be installed to couple a detector and a controller for triggering the extinguishers.

The various types of detectors are generally arranged in a protected area and are placed in the ceilings or overhead to cover a particular zone. However, if the detectors are placed in a cargo area that includes multiple containers that store cargo that is potentially flammable, there will be a delay before the detector located on the ceiling of the cargo area detects that a fire has started within the container. In addition, the wiring and tubing requirements make it difficult to integrate a detector within the container because the containers, such as those on aircraft, are oftentimes portable. The delay in detecting the fire in a container can cause an increased amount of damage to the cargo located within the container but can also increase the chances of further damage to the neighboring areas.

Disclosed herein is an integrated device that incorporates a detector, extinguisher(s) and a wireless communication module. The detector can be integrated directly with the extinguisher (or extinguishers to cover both the HRD and LRD) and is integrated wirelessly with the aircraft and/or the other integrated devices to signal an alarm or initiate the extinguishers. The techniques described herein do not require additional wiring and tubing. The extinguisher(s) can provide both HRD and LRD, or only one of the HRD or LRD can be implemented with a separate system supplementing the other system. The common integrated device can be used in multiple aircraft platforms, with the difference of the various platforms being the number and position of the integrated devices. The integrated device can be installed inside of the cargo containers as well as in the cargo area to provide increased protection from events leading to fires. In addition, the integrated devices can be installed within a cargo container along with the cargo bay. By having the ability to place the integrated component within a container, a fire that starts within the container can be extinguished in advance of an extinguisher that is located external to the container such as in a cargo area. Also, the integrated device does not require a connection to a central supply to the extinguishing agent. The integrated device does not require a controller to activate the extinguisher of the integrated device.

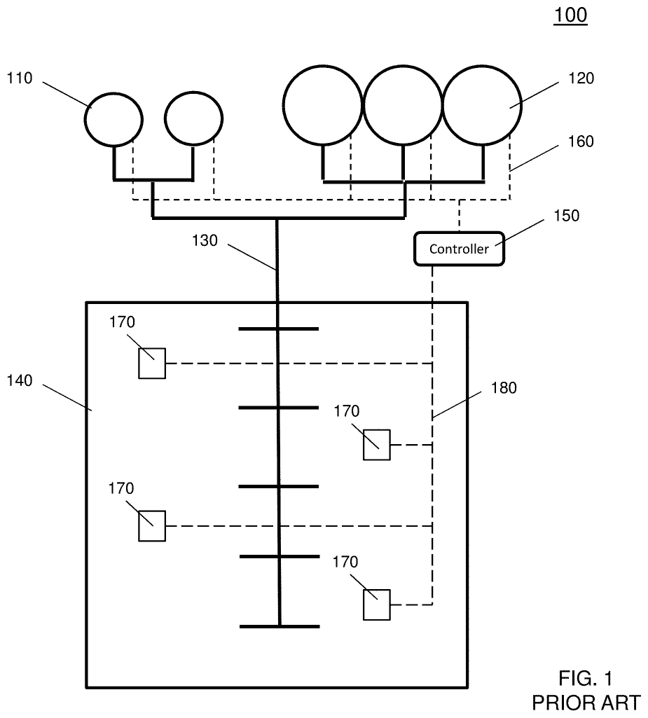

In FIG. 1, a fire extinguishing system 100 (hereinafter referred as system 100) is shown. The system 100 includes HRD extinguisher 110 and LRD extinguisher 120, which supply an extinguishing material to the area 140 through the supply line 130. The HRD extinguisher 110 and LRD extinguisher 120 are coupled to a controller 150 over a wired connection 160. In some configurations, the HRD extinguishers 110 are initially activated to rapidly provide protection. Subsequently, the LRD extinguishers 120 are provided for a longer consistent duration to extinguish the fire. The area 140, such as an aircraft cargo bay, includes a plurality of detectors 170 that are configured to detect smoke and/or fire. The detectors 170 as shown are not integrated with the extinguishers 110 and 120. The detectors 170 are connected to the controller 150 over a wired connection 180. Responsive to receiving a signal from the detectors 170, the controller 150 sends a signal to the extinguishers 110 and 120 to release the supply of extinguishing material to the area 140. The techniques described herein integrate the components of the system in a single common device.

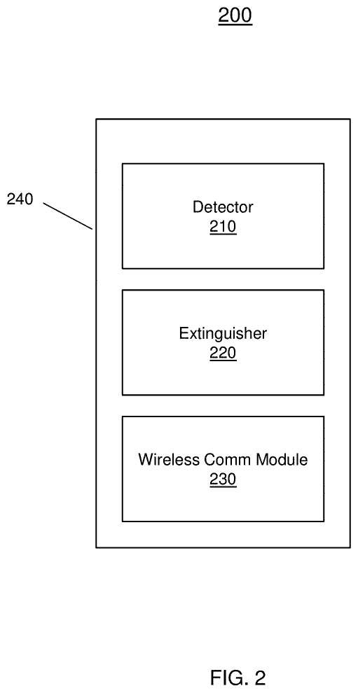

Now referring to FIG. 2, an integrated fire detection and extinguishing device 200 is shown. The device 200 includes a detector 210, an extinguisher 220, and a wireless communication module 230. In one or more embodiments, the device 200 is provided within a housing 240.

The detector 210 can include sensors such as heat detectors, smoke detectors, optical sensors, and the like. The heat detectors can include resistors and thermocouple to detect the state. The optical sensors can include infrared or ultraviolet light detectors. The sensors of the device 240 is what is in FIG. 2 can include additional sensors to sense the pressure of the extinguisher, a battery charge level of the device, or other information.

The extinguisher 220 is included within the integrated device 200 to hold the extinguishing agent. The extinguisher 220 is coupled to receive a signal from the detector 210 to release the extinguishing agent. In one or more embodiments, the extinguisher 220 can be self-released based on thermal and/or mechanical properties of the release device. For example, this can include eutectic material, pressure relief burst disc, etc. In such a case, the discharge can be detected and communicated by the wireless communication module 230.

Upon detection, the device 200 can transmit a signal or alarm through the wireless communication module 230 to other devices 200 in the area that may be at risk of the fire. The signal can trigger the surrounding devices to be activated prior to the actual detection of the fire by the detectors. The wireless communication module 230 is configured to communicate using various protocols include Wi-Fi, Bluetooth, etc. It should be understood that other low-energy wireless solutions can be used in addition to those listed above.

The wireless communication module 230 can also communicate with an aircraft system to provide an alarm to the pilot, crew, or other operator. The information that is transmitted can include an integrated device ID, the state of the integrated device 200 such as having detected smoke and/or a fire, a state of having low pressure, a battery charge state, etc. The wireless communication module 230 is also configured to transmit any other type of state or fault information.

In some embodiments, the devices 200 include its own power supply and do not rely on a wired power supply from the aircraft. In one or more embodiments, the wireless communication module 230 can transmit a battery charge level to one or more devices such as a display device of an aircraft system.

In one or more embodiments, the integrated device 200 can control the release of the extinguishing material based on the condition detected by the detector or one or more sensors. For example, the integrated device 200 can be partially or fully opened based on the condition detected by the detector 210.

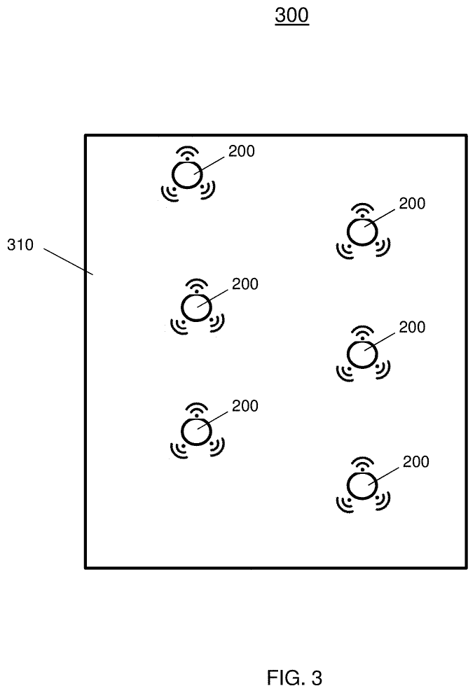

In FIG. 3, a system 300 of integrated devices 200 for an interconnected fire detection and extinguishing system is shown. The system 300 includes a plurality of integrated devices 200. Each of the integrated devices 200 include the detector, extinguisher, and wireless communication module. The integrated devices 200 can communicate with other integrated devices 200 or an aircraft system. In one or more embodiments, no controller is required to activate the integrated devices 200. Also, although only six integrated devices 200 are shown in FIG. 3, it should be understood that any number of integrated devices 200 can be used.

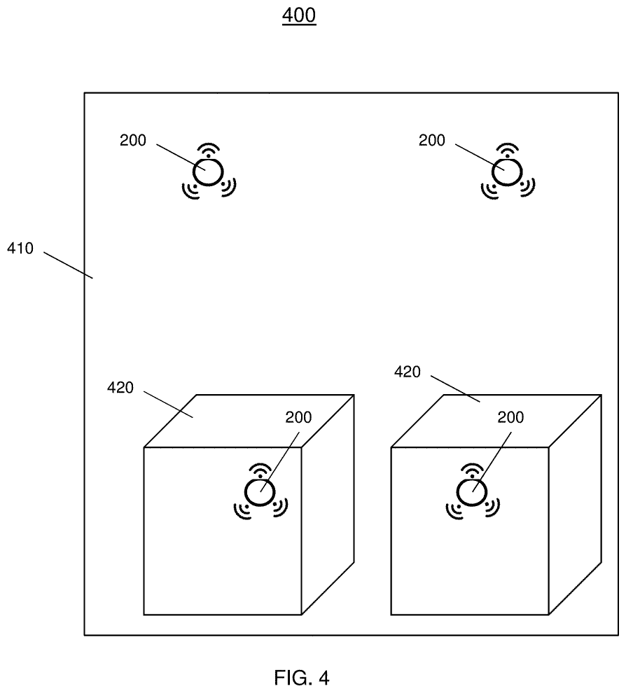

In FIG. 4, a block diagram 400 of an example cargo storage area 410 that includes a plurality of integrated devices 200. The integrated devices 200 are positioned throughout the cargo storage area 410 and within the cargo storage containers 420. The same type of integrated device 200 is provided in the cargo storage area 410 and inside the containers 420. In the event, smoke or fire is detected inside of the cargo storage container 420, the integrated device 200 can be activated and transmit a signal to activate one or more of the other integrated devices 200. In the alternative, if smoke or fire is detected outside of the container 420 in the cargo storage area 410, the integrated devices 200 outside of the cargo storage container are likely to detect the smoke or fire before those inside the cargo storage container 420 and will be activated.

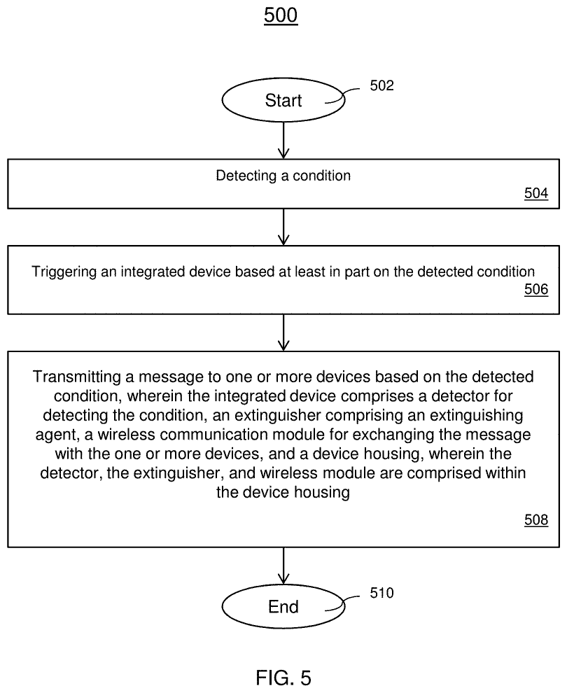

Now referring to FIG. 5, a method 500 for operating an interconnected fire detection and extinguishing system is shown. The 500 begins at block 502 and proceeds to block 504 which provides for detecting a condition. The integrated device 200 includes a detector 210 can detect smoke or fire within proximity to the integrated device 200. At block 506, the method 500 provides for triggering an integrated device based at least in part on the detected condition. Responsive to detecting smoke or fire, the detector provides a signal to the extinguisher 220 to release the extinguishing agent stored in the extinguisher 220. In another embodiment, the detected condition can include self-release of the agent stored in the extinguisher 220. The method 500 at block 508 provides for transmitting a message to one or more devices based on the detected condition, wherein the integrated device includes a detector for detecting the condition, an extinguisher including an extinguishing agent, a wireless communication module for exchanging the message with the one or more devices, and a device housing, wherein the detector, the extinguisher, and wireless module are included within the device housing. The integrated device 200 is a single device that is configured to wirelessly communicate with other integrated devices 200 or an aircraft system. The communication can include state information including, but not limited to, an integrated device ID, a pressure level, fault information, or a battery charge level. The state information can be used to wireless trigger another integrated device 200 that is in proximity of the integrated device 200 that initially detected the condition. For example, a first integrated device within a container can trigger a second integrated device in the cargo area and vice versa. The method 500 ends at block 510.

The technical effects and benefits include reducing/eliminating the wiring and tubing saving weight and cost of a system such as that of an aircraft. A common integrated component can be used between multiple platforms with efficient scalability. The technical effects and benefits include providing a common device that can be easily interchanged and incorporated into a fire suppression and/or extinguishing system.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An integrated device used in an interconnected fire detection and extinguishing system, the integrated device comprising:
a detector for detecting a condition associated with at least one of a fire or smoke;
an extinguisher operably coupled to the detector, wherein the extinguisher comprises an extinguishing agent;
a wireless communication module for exchanging messages with one or more supplemental devices based on the detected condition; and
a device housing, wherein the detector, the extinguisher, and wireless module are at least partially in the device housing.

2. The integrated device of claim 1, wherein the detector is at least one of a smoke detector, a fire detector, or an optical sensor.

3. The integrated device of claim 1, wherein the extinguishers comprises at least one of a high rate discharge extinguisher and a low rate discharge extinguisher.

4. The integrated device of claim 1, wherein the messages comprise state information of the integrated device.

5. The integrated device of claim 4, wherein the state information comprises an integrated device ID, a pressure level, fault information, or a battery charge level.

6. The integrated device of claim 1, wherein the integrated device is in at least one of a cargo storage container or in an aircraft cargo bay.

7. The integrated device of claim 1, wherein the one or more supplemental devices comprises at least one integrated device of an aircraft system.

8. A method for operating an interconnected fire detection and extinguishing system, the method comprising:
detecting a condition;
triggering an integrated device based at least in part on the detected condition; and
transmitting a message to one or more devices based on the detected condition, wherein the integrated device comprises a detector for detecting the condition, an extinguisher comprising an extinguishing agent, a wireless communication module for exchanging the message with the one or more supplemental devices, and a device housing, wherein the detector, the extinguisher, and the wireless module are at least partially in the device housing.

9. The method of claim 8, wherein the one or more supplemental devices comprises at least one integrated device of an aircraft system.

10. The method of claim 8, wherein the detector is at least one of a smoke detector, a fire detector, or an optical sensor.

11. The method of claim 8, wherein the extinguishers comprises at least one of a high rate discharge extinguisher and a low rate discharge extinguisher.

12. The method of claim 8, wherein the messages comprise state information of the integrated device.

13. The method of claim 12, wherein the state information comprises an integrated device ID, a pressure level, fault information, or a battery charge level.

14. The method of claim 8, wherein the integrated device is in a cargo storage container.

15. The method of claim 8, wherein the integrated device is in an aircraft cargo bay.

16. An interconnected fire detection and extinguishing system, the system comprising:
one or more integrated devices that are operably coupled to one or more other integrated devices;
wherein the one or more integrated devices and the one or more other integrated devices comprise a detector for detecting a condition, an extinguisher comprising an extinguishing agent, a wireless communication module for exchanging messages with one or more supplemental devices, and a device housing, wherein the detector, the extinguisher, and wireless module are comprised within the device housing.

17. The system of claim 16, wherein the one or more supplemental devices comprises at least one integrated device of an aircraft system.

18. The system of claim 16, wherein the detector is a smoke detector, fire detector, and optical detector, and wherein the extinguisher comprises at least one of a high rate discharge extinguisher and a low rate discharge extinguisher.

19. The system of claim 16, wherein the messages comprise an integrated device ID, a pressure level, fault information, or a battery charge level.

20. The system of claim 16, wherein the one or more integrated devices are located in a cargo storage container or located in an aircraft cargo bay.
